(19) United States
(12) Patent Application Publication
(10) Pub. No.: US 2025/0010275 A1
(43) Pub. Date: Jan. 9, 2025

(54) CATALYTIC SHAPED BODIES COMPRISING COPPER PHYLLOSILICATE

(71) Applicant: EVONIK OPERATIONS GMBH, Essen (DE)

(72) Inventors: Thomas QUANDT, Marl (DE); Angélique BÉTARD, Herten (DE)

(73) Assignee: EVONIK OPERATIONS GMBH, Essen (DE)

(21) Appl. No.: 18/716,077

(22) PCT Filed: Nov. 28, 2022
(86) PCT No.: PCT/EP2022/083409

§ 371 Date: Jun. 3, 2024

(30) Foreign Application Priority Data
Dec. 8, 2021 (EP) 21213160.1

(51) Int. Cl. B01J 23/72; B01J 21/08; B01J 35/50; B01J 37/00; B01J 37/02; B01J 37/08; B01J 37/12

(52) U.S. Cl. CPC B01J 23/72; B01J 21/08; B01J 35/50; B01J 37/0009; B01J 37/0205; B01J 37/08; B01J 37/12

(57) ABSTRACT

The present invention relates to processes for producing copper phyllosilicate shaped bodies, comprising the steps of:
providing a plastically deformable material comprising at least one SiO₂ source, at least one Cu source and aqueous ammonia solution,
shaping the plastically deformable material so as to obtain blanks having a longitudinal expansion of at least 0.1 mm in all directions in space,
thermally treating the blanks so as to obtain shaped bodies comprising copper phyllosilicate.

The present invention further relates to the shaped bodies obtainable by the processes according to the invention.

These shaped bodies are used, as precursor of copper/silica catalysts, in numerous chemical transformations, for example for the hydrogenation of aldehydes and ketones to alcohols or in the dehydrogenation of alcohols.

### BACKGROUND

Copper-silica catalysts are well-suited for numerous chemical transformations, for example for the hydrogenation of aldehydes and ketones to alcohols or for the dehydrogenation of alcohols. In order to permit practical use in an industrial reactor, the copper-silica catalysts need to be present in the form of shaped bodies having a minimum size of 0.5 mm, for example beads, tablets or extrudates, and have sufficiently high strength to withstand the filling of the reactor and the conditions during the reaction without damage. Most uses require a high copper loading in the catalyst, typically from 12% to 35% by weight (calculated as the mass fraction of elemental copper based on the total mass of the calcined material). The best possible dispersion of the copper in the silica matrix is also advantageous for the activity of the catalyst. The above requirements are met by shaped catalyst bodies comprising copper phyllosilicates.

The previously known processes for producing shaped bodies from copper phyllosilicates are however very laborious. In these processes, pulverulent copper phyllosilicates are obtained from aqueous suspensions, in some cases under hydrothermal conditions. These powders must then be separated from the liquid fractions of the reaction mixture, dried, calcined and processed into shaped bodies (cf. for example DE3123000A1, WO2018203836A1, Popa T et al. Applied Catalysis A: General 505 (2015) 52-61). In addition, the shaped bodies produced in this way have low strength.

In view of the need for solid copper phyllosilicate shaped bodies, it was an object of the present invention to provide simple processes for the production thereof.

### THE PRESENT INVENTION

This object is achieved by the processes of the present invention.

The processes according to the invention for producing shaped bodies comprising copper phyllosilicate comprise the following steps:
(a) providing a plastically deformable material comprising at least one SiO₂ source, at least one Cu source and aqueous ammonia solution,
(b) shaping the plastically deformable material so as to obtain blanks having a longitudinal expansion of at least 0.1 mm in all directions in space,
(c) thermally treating the blanks so as to obtain shaped bodies comprising copper phyllosilicate,
wherein the blanks, during the thermal treatment in step (c), are heated for a minimum time DTₘᵢₙ to a temperature in the range TT and the space velocity of the gas flowing around or through the blanks per hour during the thermal treatment is below SV times the volume of the blanks,
wherein DTₘᵢₙ=30 min, and
wherein the temperature range TT is between TTₘᵢₙ and TTₘₐₓ, where TTₘᵢₙ=70° C. and TTₘₐₓ=150° C., and
wherein SV=50, and
wherein the SiO₂ source is an SiO₂-containing solid having a BET surface area of at least 50 m²/g, and
wherein the Cu source is soluble in aqueous ammonia solution, and
wherein the plastically deformable material before the shaping in step (b) has a mass quotient Q=m_{solid}/m_{liquid} in the range between Qₘᵢₙ and Qₘₐₓ, where Qₘᵢₙ=0.2 and Qₘₐₓ=1, wherein m_{solid} is the total mass of all constituents of the plastically deformable material that are present in the solid state at 25° C. and m_{liquid} is the total mass of all other constituents in the plastically deformable material.

The processes according to the invention include in step (a) providing a plastically deformable material. In accordance with the established definition, what is referred to as a plastically deformable material in the present case is a heterogeneous mixture of substances with a liquid phase that undergoes lasting deformation after overcoming a yield point without the cohesion of the particles forming the substance being lost (Hermann Salmang, Horst Scholze “Keramik” [Ceramics] Springer Verlag, 7th edition (2007) page 583).

The plastically deformable material may be obtained from a mixture of SiO₂ source, Cu source and aqueous ammonia solution when the mass quotient of said mixture Q=m_{solid}/m_{liquid} is in the range between Qₘᵢₙ and Qₘₐₓ, where Qₘᵢₙ=0.2 and Qₘₐₓ=1, wherein m_{solid} is the total mass of all constituents of said mixture that are present in the solid state at 25° C. and m_{liquid} is the total mass of all other constituents of said mixture. Thorough mixing transforms a corresponding mixture into a plastically deformable material.

After the plastically deformable material has been provided, it is shaped to obtain blanks having a longitudinal expansion of at least 0.1 mm in all directions in space. Given that the blanks are typically a statistical ensemble of bodies having a certain variance in shape, this statement is to be understood as meaning that at least 90% (by number) of the blanks have after shaping a longitudinal expansion of at least 0.1 mm in all directions in space. Suitable blanks are beads, extrudates, tablets, granules and pellets. Shaping can be achieved here by a number of known methods. Examples of shaping methods that are suitable for the present process include granulation, extrusion, pressing and tabletting. In the case of extrusion, for example, the plastically deformable material is pressed through a perforated plate to obtain its shape. Examples are described for example in chapter 9 “Shaping of Solid Catalysts” of the book “Synthesis of Solid Catalysts”, ed. K. P. de Jong, Wiley-VCH Verlag Gmbh & Co. KGaA, Weinheim, Germany (2009). In a preferred embodiment, the blanks have after shaping a longitudinal expansion of at least 0.5 mm in all directions in space (at least 90% (by number) of the blanks). In a particularly preferred embodiment, the blanks have after shaping a longitudinal expansion of at least 1 mm in all directions in space (at least 90% (by number) of the blanks).

After the plastically deformable material has been shaped into blanks, the blanks undergo a thermal treatment. This can be done under ambient pressure; there is no need for the blanks to be transferred to autoclaves. This substantially reduces the amount of equipment required and considerably improves the economic efficiency of the process. The thermal treatment is carried out in a temperature range between 7° and 150° C. for at least 30 minutes. The thermal treatment of the blanks can however, if required, also be carried out at pressures above atmospheric pressure in suitable apparatus (e.g. autoclaves).

In the process according to the invention, the amount of gas flowing around or through the blanks during the thermal treatment is limited as a means of limiting the rate of drying of the blanks. For this, the space velocity of the gas flowing around or through the blanks per hour during the thermal treatment is limited to a volume below 50 times the volume of the blanks. In the case of complete or partial recirculation of the gas stream, i.e. when all of the gas or part of the gas flowing around or through the blanks during the thermal treatment is returned to the blanks, the volume of the recirculated gas stream fraction is taken into account only during its first passage through the blanks. The volume of the blanks is in this context considered to be the bulk volume of the blanks.

In the process of the present invention, no more liquid than is necessary to form the plastically deformable material need be added at any time. There is accordingly also no need for a separation step to remove liquid and also no accumulation of liquid waste associated therewith.

It is surprising here that the formation of phyllosilicates within the plastically deformable material is possible at all, given that all of the liquid present therein is in capillary-bound form, which means that mass transport is severely limited.

Even more surprising is that it is possible with the process according to the invention to produce copper phyllosilicates having a copper content of over 20% by weight (calculated as the mass fraction of elemental copper in the total weight of the material calcined at 700° C. for 3 h), since, given that the proportion of liquid constituents in the plastically deformable material is limited through restricting the solid/liquid mass quotient Q to a range between Qₘᵢₙ=0.2 and Qₘₐₓ=1, it is possible to use only a relatively small amount of Cu-containing solution. The use of appropriate amounts of Cu-containing solution would therefore not on its own permit access to copper phyllosilicates having a copper content of over 20% by weight. This only becomes possible if, in addition to Cu-containing solutions, Cu sources in dry form are added to the plastically deformable material. These must however have sufficient solubility in aqueous ammonia.

The SiO₂ source according to the present invention is an SiO₂-containing solid having a BET surface area of at least 50 m²/g.

The Cu source according to the present invention is a Cu-containing compound or a mixture of Cu-containing compounds that is soluble in aqueous ammonia solution. A Cu source is considered soluble in aqueous ammonia solution if it dissolves in a 25% solution (i.e. 25% by weight NH₃ in H₂O) in a concentration of at least 100*10⁻³ mol l⁻¹. The Cu source may be in the form of a solid or in dissolved form.

The concentration of the aqueous ammonia solution used in step (a) should be chosen such that the mass fraction of NH₃ in the total mass of all non-solid constituents of the plastically deformable material in step (a) is at least 3%.

The molar ratio of SiO₂ source to Cu source may be varied within a wide range. An excess of SiO₂ source is noncritical in principle, but increases the proportion of untransformed SiO₂ in the shaped catalyst body, thereby reducing its specific activity per unit mass. An excess of Cu source is likewise noncritical in principle, but can also result in the presence of an increased proportion of catalytically inactive catalyst mass and thus in reduced specific activity per unit mass. Good results can usually be achieved with a molar ratio n (Si) [in the SiO₂ source]/n(Cu) [in the Cu source] in the range from 2 to 10.

The plastically deformable material in step (a) may comprise further constituents besides SiO₂ source, Cu source and aqueous ammonia solution, but these must not hinder the plastic deformability of the material. Examples of further constituents are additives and/or dopants.

Suitable additives include in particular plasticizing agents, pore formers or parting agents. Examples of typical plasticizing agents are cellulose ethers, polysaccharides, starch, polyethers and polymeric alcohols. Examples of typical parting agents are waxes, wax dispersions and fatty acids. Examples of typical pore formers are cellulose, cellulose ethers, polysaccharides, starch, polyethers, polymeric alcohols, waxes, wax dispersions and fatty acids.

Suitable dopants are in particular water-soluble salts of alkali metals or alkaline earth metals. The mass fraction of the totality of all dopants used should here not be more than 5% by weight (calculated as the mass fraction of elemental dopants in the total mass of the material calcined at 700° C. for 3 h).

In a preferred embodiment of the process according to the invention, in the thermal treatment in step (c), TTₘᵢₙ=80° C. and TTₘₐₓ=130° C.

In a preferred embodiment of the process according to the invention, in the thermal treatment in step (c), the space velocity of the gas flowing around or through the blanks per hour during the thermal treatment is less than 25 times the volume of the blanks. In the case of complete or partial recirculation of the gas stream, i.e. when all of the gas or part of the gas flowing around or through the blanks during the thermal treatment is returned to the blanks, the volume of the recirculated gas stream fraction is taken into account only during its first passage through the blanks. The volume of the blanks is in this context considered to be the bulk volume of the blanks.

In a preferred embodiment of the process according to the invention, the SiO₂ source is selected from: precipitated silica, fumed silica, mixtures of precipitated silica and fumed silica.

In a preferred embodiment of the process according to the invention, the Cu source is one of the following Cu-containing compounds or a mixture of at least two thereof: Cu₂(OH)₂CO₃, Cu(NO₃)₂·3H₂O, compounds containing [Cu(NH₃)₄]²⁺ cations (tetraamminecopper(II) compounds). There are numerous compounds that contain [Cu(NH₃)₄]²⁺ cations, for example tetraamminecopper dihydroxide, tetraamminecopper(II) carbonate and tetraamminecopper(II) sulfate. These compounds generally have very good solubility in water and in aqueous ammonia solutions.

In a particularly preferred embodiment of the process according to the invention, the Cu source is one of the following Cu-containing compounds or a mixture of at least two thereof: Cu₂(OH)₂CO₃, compounds containing [Cu(NH₃)₄]²⁺ cations (tetraamminecopper(II) compounds).

In a preferred embodiment of the process according to the invention, the plastically deformable material has a copper content X(Cu) in the range between X(Cu)ₘᵢₙ and X(Cu)ₘₐₓ, where X(Cu)ₘᵢₙ=10% by weight and X(Cu)ₘₐₓ=40% by weight, calculated as the mass fraction of elemental copper in the total weight of the material calcined at 700° C. for 3 h. The copper content X(Cu) of the plastically deformable material calculated as the mass fraction of elemental copper in the total weight of the material calcined at 700° C. for 3 h is determined here as follows: First, the plastically deformable material is subjected to a thermal treatment as in step (c) and the material obtained thereby is then heated to 700° C. for three hours. After cooling, the material is weighed and its copper content determined. The copper content can be determined by usual analytical methods, such as atomic emission spectrometry and X-ray fluorescence analysis.

In a particularly preferred embodiment of the process according to the invention, the plastically deformable material has a copper content X(Cu) in the range between X(Cu)ₘᵢₙ and X(Cu)ₘₐₓ, where X(Cu)ₘᵢₙ=16% by weight and X(Cu)ₘₐₓ=33% by weight, calculated as the mass fraction of elemental copper in the total weight of the material calcined at 700° C. for 3 h.

In a preferred embodiment of the process according to the invention, the blanks before the start of the thermal treatment in step (c) have a loss on drying at 110° C. of not more than LOD % by weight, where LOD=55. The loss on drying at 110° C. is determined here as follows: The material sample under investigation is initially weighed (m[start weight]); the material sample is then dried in a drying oven at 110° C. for a period of 6 h; after which it is allowed to cool in a desiccator and then reweighed (m[end weight]); the loss on drying (LOD) at 110° C. is then calculated as follows: LOD=100%*(m[start weight]−m[end weight])/m[start weight].

In a preferred embodiment of the process according to the invention, the plastically deformable material before shaping in step (b) has a mass quotient Q=m_{solid}/m_{liquid} in the range between Qₘᵢₙ and Qₘₐₓ, where Qₘᵢₙ=0.5 and Qₘₐₓ=1.

In a preferred embodiment, the process according to the invention additionally includes, after the thermal treatment (c), a drying (d1) in which the shaped bodies are heated to temperatures in the range between 100° C. and 150° C. until they have a loss on drying (LOD) at 110° C. of not more than 2% by weight. The loss on drying at 110° C. is determined here as follows: The material sample under investigation is initially weighed (m[start weight]); the material sample is then dried in a drying oven at 110° C. for a period of 6 h; after which it is allowed to cool in a desiccator and then reweighed (m[end weight]); the loss on drying (LOD) at 110° C. is then calculated as follows: LOD=100%*(m[start weight]−m[end weight])/m[start weight].

In a further preferred embodiment, the process according to the invention additionally includes a calcining (d2) in which the shaped bodies are heated to temperatures within a range from 400° C. to 700° C. for a period of 0.5 h to 20 h, wherein the calcining (d2) can either follow on directly from the thermal treatment in step (c) or from a drying (d1) following the thermal treatment in step (c).

Both after drying (d1) and after calcining (d2), it is possible for shaping of the shaped bodies present at this point into differently shaped, typically larger, shaped bodies to take place according to processes known to those skilled in the art. Binders may also be employed for this purpose.

In a further preferred embodiment, the process according to the invention additionally includes a treatment of the copper phyllosilicate shaped bodies with hydrogen (d3), in which the shaped bodies are contacted with hydrogen and active catalysts are subsequently obtained. The treatment with hydrogen (d3) may either follow on directly here from the thermal treatment in step (c) or from one of the two steps (d1) and (d2) or a combination thereof.

In a further aspect, the present invention additionally encompasses copper phyllosilicate shaped bodies obtainable by the process according to the invention. These shaped bodies have high porosity that makes it possible for them to be used commercially. Moreover, the shaped bodies obtained by the process according to the invention have a high side crush strength of over 30 N that in comparative experiments could not be achieved for shaped bodies produced by subsequent shaping of pulverulent copper phyllosilicates that had been obtained with processes from the prior art (cf. experimental section). The side crush strength was measured here in each case on 20 test specimens 3.5±0.5 mm in length using an Erweka TBH 255 tester at a constant force increase of 50 N/s.

In a preferred embodiment, the present invention encompasses copper phyllosilicate shaped bodies obtainable by the process according to the invention that contain no shaping additives and that have a side crush strength of more than 30 N, measured using an Erweka TBH 255 tester at a constant force increase of 50 N/s.

In a further aspect, the present invention additionally encompasses the use of the copper phyllosilicate shaped bodies as precursor of active catalysts.

The active catalysts obtained by treating the copper phyllosilicate shaped bodies with hydrogen have a high side crush strength, as do the copper phyllosilicate shaped bodies according to the invention used as starting material. Correspondingly high side crush strengths could not be achieved for catalysts obtained from copper phyllosilicate shaped bodies that had been obtained by subsequent shaping of pulverulent copper phyllosilicates from processes of the prior art. In a further aspect, the present invention accordingly also encompasses the catalysts obtained from the copper phyllosilicate shaped bodies according to the invention through treatment with hydrogen.

The present invention additionally encompasses the use of the catalysts according to the invention in chemical transformations.

The present invention additionally encompasses the use of the catalysts according to the invention for the hydrogenation of aldehydes or ketones to alcohols and for the dehydrogenation of alcohols.

In the context of the present invention, substances that influence the reaction rate of a chemical reaction without being consumed by the influenced chemical reaction itself are referred to as catalysts. In the context of the present invention, substances that are activated only in situ, i.e. are converted into the catalytically active species only by an activating transformation in the course of performing the reaction are referred to as catalysts too.

### EXAMPLES

Values for BET surface area were determined in accordance with DIN ISO 9277.

Unless otherwise stated, mass fractions were calculated as the mass fraction of the elemental metal in the total mass of the material calcined at 700° C. for 3 h.

Values for side crush strength were determined using an Erweka TBH 255 tester. In each case 20 compacts having a length of 3.5±0.5 mm were measured while compressing with a constant force increase of 50 N/s. Measurement was followed by determination of the average value. In addition, the diameter of each particle was determined and the average for the 20 compacts in each case calculated.

Thermal treatments and drying operations were carried out using a VTU 60/60 drying oven and a VTU 75/100 drying oven (both from Vötsch). The drying ovens respectively achieve exhaust air volume flows of 102 m³/h and 240 m³/h. The high recirculated air volume flows mean that the whole interior is subject to flow. This corresponds to a gas hourly space velocity of the recirculated air flow of 276 or 427 m³/h/m³ based on the whole interior of the drying ovens. Since the amount of substrate treated was in each case not more than 2 l, the gas hourly space velocity of the gas flowing around or through the treated substrate in the drying oven per hour was at least 50 000 l/h/l_{substrate}.

For the recording of the X-ray diffractograms, the extrudates were milled. The diffractograms were recorded in Bragg-Brentano geometry using XRD instruments from PANalytical. Radiation sources were a Cu tube. Phase assignment was by comparison with literature sources (see example A1) and the Powder Diffraction File database.

### Production of a Tetraamminecopper(II) Carbonate Solution

A vessel with a closing lid and stirrer was charged with 1000 g of demineralized water and 3000 g of ammonia solution (32% by weight NH₃). To this were added portionwise with stirring 633 g of ammonium hydrogen carbonate and 1421 g of copper hydroxide carbonate (TIB, 55% by weight elemental Cu). The solution was stirred for 3 hours. The resulting solution was dark blue, homogeneous and contained about 13.3% by weight of Cu and 15.3% by weight of NH₃.

### Shaped Bodies A1: Cu/SiO₂ Shaped Bodies Having a Mass Fraction of 32% by Weight of Elemental Copper (Inventive)

666 g of Sipernat® 320 (Evonik, BET surface area 180 m²/g) was mixed together with 353 g of copper hydroxide carbonate (Dr. Paul Lohmann, 55 g of elemental Cu per 100 g of substance) in an Eirich intensive mixer (10 l). 990 g of tetraamminecopper(II) carbonate solution was added to the powder mixture and the resulting mixture was granulated to a size of 1-3 mm with the addition of 230 g of demineralized water. The granules were fed to a ring die press from Schlüter and processed into 3.2 mm compacts. 1883 g of smooth and uniform extrudates were obtained. The shaped bodies were placed on a metal sheet and covered with a further metal sheet and stored for 20 h in a drying oven heated to 100° C. The airflow through or over the compacts was virtually zero. After this treatment, the extrudates had a loss on drying at 110° C. of 10%. The dried shaped bodies were treated in a calcining furnace at 450° C. for 2 h. The finished shaped bodies were dark green, had a BET surface area of 453 m²/g and a side crush strength of 63 N. The x-ray diffractogram showed weak reflections attributable to silica and chrysocolla phases. A CuO phase was not apparent. The high BET surface area and the typical X-ray diffractogram demonstrate the presence of copper phyllosilicate as described in the literature (for example Pompe, Slagter et al. 2018, Chen, Zhang et al. 2017).

### Shaped Bodies A2: Cu/SiO₂ Shaped Bodies Having a Mass Fraction of 32% by Weight of Elemental Copper (Noninventive)

The extrudates were produced as in example A1, distributed on a sieve tray in a thickness of 1-2 cm, treated uncovered in a drying oven at 130° C. and then calcined as in example A1. The finished shaped bodies were predominantly black and had a BET surface area of 129 m²/g and a side crush strength of 25 N. The X-ray diffractogram showed the presence of silica and CuO particles with a crystallite size of 12 nm.

### Shaped Bodies A3: Cu/SiO₂ Shaped Bodies Having a Mass Fraction of 32% by Weight of Elemental Copper (Noninventive)

The extrudates were produced as in example A1, distributed on a sieve tray in a thickness of 1-2 cm, treated uncovered in a drying oven at 80° C. and then calcined as in example A1. The finished shaped bodies were predominantly black and had a BET surface area of 119 m²/g and a side crush strength of 29 N. The X-ray diffractogram showed the presence of silica and CuO particles with a crystallite size of 14 nm.

### Shaped Bodies A4: Cu/SiO₂ Shaped Bodies Having a Mass Fraction of 32% by Weight of Elemental Copper (Inventive)

The extrudates were produced as in example A1. 500 g of extrudates were transferred to the flask of a rotary evaporator and thermally treated at a bath temperature of 110° C. The evaporator was operated at atmospheric pressure and with venting. The airflow in the flask was however virtually zero. After 3 h of treatment, the extrudates were transferred to a sieve tray, then dried in a drying oven at 110° C. for 14 h and subsequently calcined as in example A1. The finished shaped bodies were predominantly green, had a BET surface area of 450 m²/g and a side crush strength of 34 N. The X-ray diffractogram showed the presence of silica and chrysocolla phases.

### Shaped Bodies A5: Cu/SiO₂ Shaped Bodies Having a Mass Fraction of 32% by Weight of Elemental Copper (Inventive)

The extrudates were produced as in example A1, but production was scaled up to a 200 l mixer. Approximately 700 kg of extrudates were transferred to a 2 m³ double-cone mixer and heated to a bed temperature of 80° C. by means of double-jacketed heating. The temperature was maintained for 4 h. During the treatment, the mixer was purged with 30 Nm³/h of nitrogen under atmospheric pressure. The extrudates then underwent final drying at 120° C. using a vibratory fluidized-bed dryer and were subsequently calcined at 450° C. The finished shaped bodies were predominantly green, had a BET surface area of 478 m²/g and a side crush strength of 72 N. The X-ray diffractogram showed the presence of silica and chrysocolla phases.

### Shaped Bodies B1: Cu/Ba/SiO₂ Shaped Bodies Having a Mass Fraction of 16% by Weight of Elemental Copper and a Mass Fraction of 4.475% by Weight of Elemental Barium (Inventive)

An Eirich intensive mixer (5 l) was initially charged with 542 g of Sipernat 320 (Evonik). To this were added 224 g of barium acetate solution (13% by weight barium, Möller Chemie) and 759 g of tetraamminecopper carbonate solution and the mixture was granulated to a size of 1 to 3 mm. Three identical granulation operations were performed, after which the three batches were mixed and shaped by passage through a ring die press from Schlüter having 1.8 mm holes in the cylinder. 4255 g of smooth and uniform shaped bodies were obtained.

3162 g of shaped bodies were transferred to a 5 l reactor and heated from room temperature to 120° C. at a heating rate of 2 K/min with supply of 0.125 m³/h of air, corresponding to a gas hourly space velocity (GHSV) of 25 h⁻¹. After 2.5 h, the airflow was increased to 0.250 m³/h, and after a further 2.5 h to 0.375 m³/h (GHSV of 50 h⁻¹). Once the temperature at the reactor outlet had after 32 h risen to 110° C., the drying was complete. The dried extrudates were transferred to a 5 l reactor and heated from 120° C. to 450° C. at a heating rate of 2 K/min with supply of 4.6 m³/h of N₂. On reaching a temperature of 450° C., nitrogen was gradually replaced by air over a period of 1.5 h until a pure air stream was achieved. Once the switch to 4.6 m³/h of air was complete, these conditions were maintained for 10.0 h. After cooling and opening the reactor 1375 g of shaped bodies were obtained.

The shaped bodies were predominantly green, had a side crush strength of 43 N, a diameter of 1.68 mm and a BET surface area of 245 m²/g. Although only barium carbonates and barium sulfates were apparent in the X-ray diffractogram, the green colour of the shaped bodies, their increased BET surface area and their high side crush strength compared to shaped bodies B2 were indicative of the presence of copper phyllosilicate.

### Shaped Bodies B2: Cu/Ba/SiO₂ Shaped Bodies Having a Mass Fraction of 16% by Weight of Elemental Copper and a Mass Fraction of 4.475% by Weight of Elemental Barium (Noninventive)

1090 g of shaped bodies were produced as in the preceding example as far as the drying. The shaped bodies were distributed on a sieve tray in a thickness of 1-2 cm and treated for 20 h in a drying oven heated to 120° C. The shaped bodies were then treated for 10 h in a muffle furnace at 450° C.

The finished shaped bodies were black, had a diameter of 1.64 mm, a side crush strength of 17 N and a BET surface area of 120 m²/g. The X-ray diffractogram showed the presence of CuO and BaCO₃.

### Shaped Bodies C: Cu/SiO₂ Shaped Bodies Having a Mass Fraction of 30.4% by Weight of Elemental Copper (Inventive)—Different Silica Source

533 g of Aerosil® 200V (Evonik) were mixed together with 283 g of copper hydroxide carbonate (Dr. Paul Lohmann, 55 g of elemental Cu per 100 g of substance) in an Eirich intensive mixer (5 l). 792 g of tetraamminecopper(II) carbonate solution were added to the powder mixture and the resulting mixture was granulated to a size of 1-3 mm with addition of 290 g of demineralized water. The granules were fed to a ring die press from Schlüter and processed into 3.2 mm compacts. 1722 g of smooth and uniform extrudates were obtained.

500 g of extrudates were transferred to the flask of a rotary evaporator and treated at a bath temperature of 130° C. The evaporator was operated at atmospheric pressure and with venting. The airflow in the flask was however virtually zero. After 3 h of treatment, the extrudates were transferred to a sieve tray and then dried in a drying oven at 120° C. for 15 h and subsequently calcined as in example A1. The finished shaped bodies were predominantly green, had a BET surface area of 499 m²/g and a side crush strength of 58 N. The X-ray diffractogram showed the presence of the chrysocolla phase.

### Shaped Bodies D: CuO/SiO₂ Shaped Bodies Having a Mass Fraction of 20% by Weight of Elemental Copper (Noninventive)

A powder containing copper phyllosilicate was produced by the process described in Popa, Zhang et al. 2015. 500 g of copper nitrate trihydrate (Celtic Chemicals Ltd.) was dissolved in 1727 g of demineralized water and 682 g of 32% NH₃ solution. After stirring for 30 min, 1638 g of colloidal silica (Köstrosol 0830 AS, CWK) were added and the solution stirred for 4 h. The solution was concentrated in several portions until the solution had reached pH 7 after about 2 hours. The product was filtered off, washed, dried in a drying oven at 89° C. for 10 h and then calcined in a muffle furnace at 450° C. for 4 h. The green powder had a BET surface area of 393 m²/g.

250 g of powder were transferred to an Eirich intensive mixer (1 l) and granulated with addition of 280 ml of water. The finished granules were shaped in a ring die press from Schlüter having 3.2 mm holes in the cylinder, distributed over a sieve tray in a thickness of 1-2 cm and dried at 100° C. for 16 h. The shaped bodies were then calcined at 450° C. for 5 h. The finished shaped bodies were green and had a side crush strength of 16 N. The X-ray diffractogram showed the presence of the chrysocolla phase.

Experimental parameters and results for examples A to C are summarized in the table below. It is apparent therefrom that the shaped bodies produced by the process according to the invention have a higher side crush strength than shaped bodies obtained by other processes. NB: High BET surface areas are typical for phyllosilicates.

### LITERATURE

Chen, Z., J. Zhang, M. Abbas, Y. Xue, J. Sun, K. Liu and J. Chen (2017). “Effect of Configuration Addition of Precursors on Structure and Catalysis of Cu/SiO2 Catalysts Prepared by Ammonia Evaporation-Hydrothermal Method.” Industrial & Engineering Chemistry Research 56 (33): 9285-9292.
Pompe, C. E., M. Slagter, P. E. de Jongh and K. P. de Jong (2018). “Impact of heterogeneities in silica-supported copper catalysts on their stability for methanol synthesis.” Journal of Catalysis 365:1-9.
Popa, T., Y. Zhang, E. Jin and M. Fan (2015). “An environmentally benign and low-cost approach to synthesis of thermally stable industrial catalyst Cu/SiO₂ for the hydrogenation of dimethyl oxalate to ethylene glycol.” Applied Catalysis A: General 505:52-61.

| | Cu | Ba | GHSV | Diameter of | BET | Side | | |
|---|---|---|---|---|---|---|---|---|
| | content | content | through | the shaped | surface | crush | | Cu-containing |
| | [% by | [% by | or over | bodies | area | strength | | phase according |
| Shaped bodies | weight] | weight] | bed [1/h] | [mm] | [m²/g] | [N] | Colour | to X-ray diffraction |
| A1 (inventive) | 32 | 0 | 0 | 2.84 | 453 | 63 | green | Chrysocolla |
| A2 (noninventive) | 32 | 0 | >50 000 | 2.91 | 129 | 25 | black | CuO |
| A3 (noninventive) | 32 | 0 | >50 000 | 2.88 | 119 | 29 | black | CuO |
| A4 (inventive) | 32 | 0 | 0 | 3.11 | 450 | 34 | green | Chrysocolla |
| A5 (inventive) | 32 | 0 | 15 | 3.04 | 478 | 72 | green | Chrysocolla |
| B1 (inventive) | 16 | 4.5 | 25 | 1.68 | 245 | 43 | green | none |
| B2 (noninventive) | 16 | 4.5 | >50 000 | 1.64 | 120 | 17 | black | CuO |
| C (inventive) | 30.4 | 0 | 0 | 2.94 | 499 | 58 | green | Chrysocolla |

1-18. (canceled)

19. A process for producing shaped bodies comprising copper phyllosilicate, said process comprising the following steps:
(a) providing a plastically deformable material comprising at least one SiO₂ source, at least one Cu source and an aqueous ammonia solution;
(b) shaping the plastically deformable material so as to obtain blanks having a longitudinal expansion of at least 0.1 mm in all directions in space;
(c) thermally treating the blanks so as to obtain shaped bodies comprising copper phyllosilicate;
wherein, during the thermal treatment in step (c), the blanks are heated for a minimum time DTₘᵢₙ to a temperature in the range TT and the space velocity of the gas flowing around or through the blanks per hour during the thermal treatment is below SV times the volume of the blanks, wherein:
DTₘᵢₙ=30 min;
the temperature range TT is between TTₘᵢₙ and TTₘₐₓ, where TTₘᵢₙ=70° C. and TTₘₐₓ=150° C.;
SV=50;
the SiO₂ source is an SiO₂-containing solid having a BET surface area, measured according to DIN ISO 9277, of at least 50 m²/g;
the Cu source is soluble in aqueous ammonia solution; and
the plastically deformable material, before the shaping in step (b), has a mass quotient Q=m_{solid}/m_{liquid} in the range between Qₘᵢₙ and Qₘₐₓ, where Qₘᵢₙ=0.2 and Qₘₐₓ=1, and wherein m_{solid} is the total mass of all constituents of the plastically deformable material that are present in the solid state at 25° C. and m_{liquid} is the total mass of all other constituents in the plastically deformable material.

20. The process of claim 19, wherein TTₘᵢₙ=80° C. and TTₘₐₓ=130° C.

21. The process of claim 19, wherein SV=25.

22. The process of claim 19, wherein the SiO₂ source is selected from group consisting of: precipitated silica, fumed silica, and mixtures thereof.

23. The process of claim 19, wherein the Cu source is selected from the group consisting of: Cu₂(OH)₂CO₃; Cu(NO₃)₂·3H₂O; and compounds containing [Cu(NH₃)₄]²⁺ cations (tetraamminecopper(II) compounds); and mixtures thereof.

24. The process of claim 19, wherein the plastically deformable material has a copper content X(Cu) in the range between X(Cu)ₘᵢₙ and X(Cu)ₘₐₓ; where X(Cu)ₘᵢₙ=10% by weight and X(Cu)ₘₐₓ=40% by weight, calculated as the mass fraction of elemental copper in the total weight of the material calcined at 700° C. for 3 h.

25. The process of claim 23, wherein X(Cu)ₘᵢₙ=16% by weight and X(Cu)ₘₐₓ=33% by weight.

26. The process of claim 19, wherein the blanks before the start of the thermal treatment in step (c) have a loss on drying at 110° C. of not more than LOD % by weight, where LOD=55.

27. The process of claim 19, wherein the plastically deformable material before shaping in step (b) has a mass quotient Q=m_{solid}/m_{liquid} in the range between Qₘᵢₙ and Qₘₐₓ, where Qₘᵢₙ=0.5 and Qₘₐₓ=1.

28. The process of claim 19, further comprising, after the thermal treatment (c), a drying step (d1) in which the shaped bodies are heated to temperatures in a range between 100° C. and 150° C. until they have a loss on drying at 110° C. of not more than 2% by weight.

29. The process of claim 19, further comprising a calcining step (d2) in which the shaped bodies are heated to temperatures within a range from 400° C. to 700° C. for a period of 0.5 h to 20 h, wherein step (d2) can either follow directly after the thermal treatment in step (c) or directly after drying step (d1).

30. The process of claim 19, further comprising a step of treating the copper phyllosilicate shaped bodies with hydrogen (d3), to obtain active catalysts, wherein step (d3) may either follow directly after the thermal treatment in step (c), step (d1) or step (d2).

31. The process of claim 20, wherein SV=25.

32. The process of claim 31, wherein the SiO₂ source is selected from group consisting of: precipitated silica; fumed silica; and mixtures thereof.

33. The process of claim 32, wherein the Cu source is selected from the group consisting of: Cu₂(OH)₂CO₃; Cu(NO₃)₂·3H₂O; compounds containing [Cu(NH₃)₄]²⁺ cations (tetraamminecopper(II) compounds); and mixtures thereof.

34. The process of claim 31, wherein the plastically deformable material has a copper content X(Cu) in the range between X(Cu)ₘᵢₙ and X(Cu)ₘₐₓ; where X(Cu)ₘᵢₙ=10% by weight and X(Cu)ₘₐₓ=40% by weight, calculated as the mass fraction of elemental copper in the total weight of the material calcined at 700° C. for 3 h.

35. The process of claim 32, wherein the blanks before the start of the thermal treatment in step (c) have a loss on drying at 110° C. of not more than LOD % by weight, where LOD=55.

36. The process of claim 31, wherein the plastically deformable material before shaping in step (b) has a mass quotient Q=m_{solid}/m_{liquid} in the range between Qₘᵢₙ and Qₘₐₓ, where Qₘᵢₙ=0.5 and Qₘₐₓ=1.

37. A shaped body made by the process of claim 19.

38. The shaped body of claim 37, wherein said shaped body acts as a catalyst.
